(19) United States
(12) Patent Application Publication
(10) Pub. No.: US 2020/0387987 A1
(43) Pub. Date: Dec. 10, 2020

(54) System For Identifying Points Of Interest To A User

(71) Applicant: SAMT, LLC, Incline Village, NV (US)

(72) Inventors: Steven Thomason, Incline Village, NV (US); Amanda Thomason, Incline Village, NV (US); Mitch Harbaugh, Incline Village, NV (US); Timothy Page, Orleton (GB)

(21) Appl. No.: 16/818,573

(22) Filed: Mar. 13, 2020

Related U.S. Application Data
(60) Provisional application No. 62/817,822, filed on Mar. 13, 2019.

(51) Int. Cl. G06Q 50/14; G06Q 30/02; G06Q 50/00; G06F 16/29; G06F 9/54; G06F 16/9535; G06F 16/9538; G06F 16/9537; G01C 21/36; G01C 21/34

(52) U.S. Cl. CPC G06Q 50/14; G06Q 30/0205; G06Q 50/01; G06F 16/29; G01C 21/3476; G06F 16/9535; G06F 16/9538; G06F 16/9537; G01C 21/3682; G06F 9/547

(57) ABSTRACT

A system for identifying a point of interest to a user while on a land based journey is disclosed. The system comprises a cloud-based database soring a plurality of location based points of interest, an internet accessible mobile communications device, and an internet accessible, cloud-based application programming interface (API). The API is adapted to permit the mobile communications device to access the cloud-based database. The mobile communications device is adapted to selectively retrieve from the cloud-based database, a location based point of interest within a user selected distance from a geographical position, and display to the user the retrieved point of interest.

### FIELD OF THE INVENTION

The present invention relates to a system for identifying one or more points of interest to a user while on a journey, such as a driving trip.

### BACKGROUND OF THE INVENTION

While traveling on a journey, such as a cross-country driving trip, which may often be limited to interstate highways, one may often miss nearby, interesting points-of-interest, such as historical sites, along the way.

The present invention is provided to address this and other problems.

### SUMMARY

In accordance with the invention, a system is provided for identifying, or otherwise providing, one or more users with points of interest to go discover whilst on a journey from point A to point B. The system may facilitate getting people “off the beaten track” of their journey and go discover places that they might not otherwise encounter.

Other features and advantages of the present invention should become apparent from the following description of the preferred embodiment, taken in conjunction with the accompanying drawings, which illustrate, by way of example, principles of the invention.

### DESCRIPTION OF THE FIGURES

For a more complete understanding of the disclosure, reference should be made to the following detailed description and accompanying drawings, wherein:

FIG. 1 is a diagram of a system in accordance with the present invention;

FIGS. 2a-2c, 3a-3c, 4a-4b, 5a-5b, 6a-6c, 7a-7c, 8, 9 and 10a-10b illustrate various mobile communication device screens for accessing and utilizing the system of FIG. 1.

### DESCRIPTION OF THE PREFERRED EMBODIMENTS

While this invention is susceptible of embodiment in many different forms, there will be described herein in detail, specific embodiments thereof with the understanding that the present disclosure is to be considered exemplifications of the principles of the invention and is not intended to limit the invention to the specific embodiments illustrated.

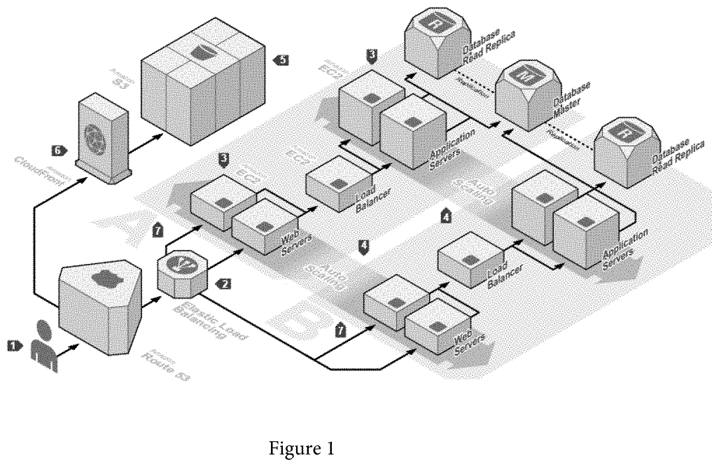

In accordance with the present invention, a system for identifying, or otherwise providing, one or more users with points of interest to go discover, such as while on a driving, biking or other journey, is illustrated in FIG. 1.

Referring to FIG. 1, the system may include a set of mobile applications, or apps, 1, operable by a user, such as on a conventional mobile communications device. The mobile device may have access to the internet, such as via a conventional cellular connection. The system may further include a cloud-based application programming interface, or API, and associated services, and a large-scale database. Server components and database may be on-demand scalable, such as using Amazon Web Service's Elastic Cloud Computing and Route 53 routing service. The system may also make use of Amazon's S3 storage facilities and CloudFront caching for media delivery across the planet.

The system may further include an Elastic Load Balancer, or ELB, 2, for intelligently routing traffic based on incoming heuristics.

The system may further include an Elastic Computing Cloud, or ECB, 3 for computing instances that perform trigger/response web & application work.

The system may further include Auto Scaling 4 for creating new instances based on load.

The system may further include an Amazon S3 Bucket 5 for secure storage of data (i.e., media files, etc.)

The system may further include Cloudfront 6 for worldwide security, delivery and caching of images and video files.

The system may further include Access Zones 7 for local installation of services based on geographical location(s).

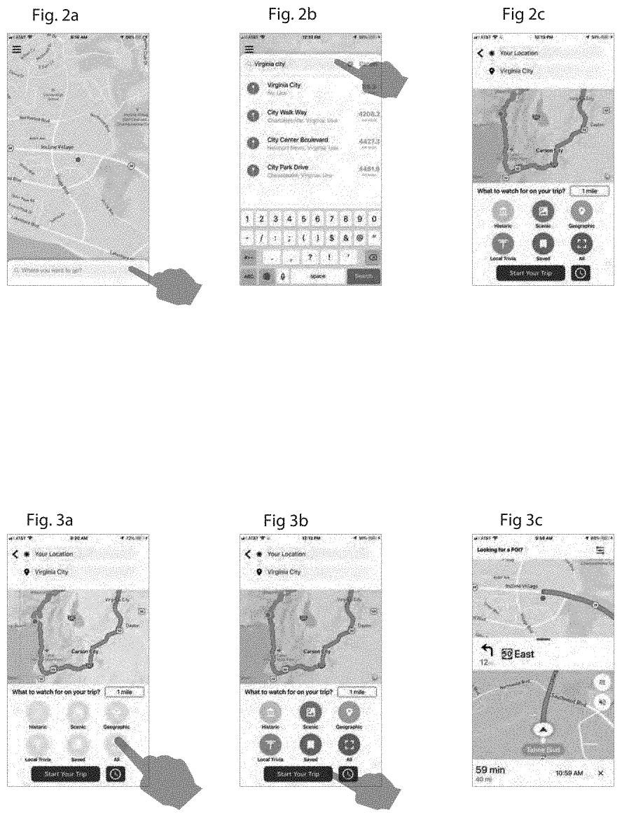

FIGS. 2-10 generally disclose operation of the system.

The user may enter a final destination into a provided mobile application, accessible via the mobile communications device. (See FIGS. 2a-2c). As illustrated in FIG. 2a, a user may start by entering a city in a “Where Do You Want to Go” field. As illustrated in FIG. 2b, the screen may expand and begin to autofill to show destination options. And as illustrated in FIG. 2c, once selected, the user may be taken to the next step for selecting POI (point-of-interest) preferences.

The user may then tell the application (i.e., conventionally input an instruction to the application) what category, or categories, of interesting, or otherwise desired, places along the route the user would be interested in seeing. (See FIGS. 3a-3c). As illustrated in FIG. 3a, the user may select which POI subjects, the user wishes to see. As illustrated in FIG. 3b, once subjects are chosen, the user may select “Start Trip” or save for later. As illustrated in FIG. 3c, when the user starts the trip, the user may be shown the full route (above), and driving navigation (below).

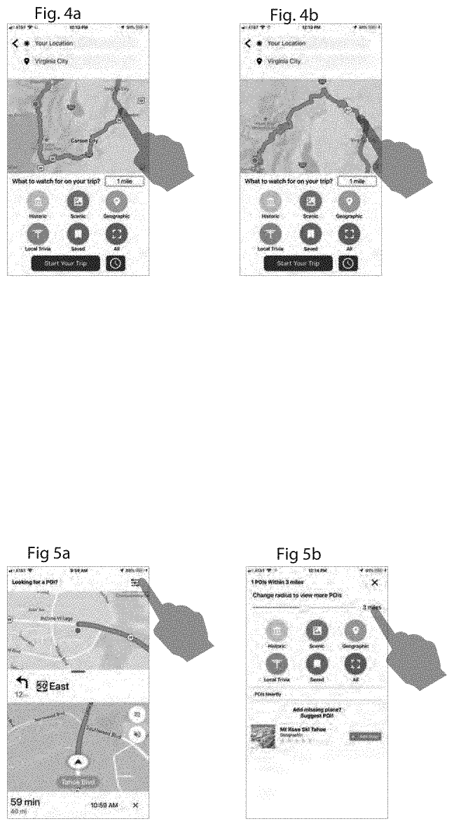

The application may then suggest routes to the user, to get to that final destination. (See FIGS. 4a-4b). As illustrated in FIGS. 4a and 4b, the user may be shown alternate routes from which to choose.

The user may provide restrictions to the application on how far off the route the user is willing to venture. (See FIGS. 5a-5b) As illustrated in FIGS. 5a, during the trip, the user may choose the filter to change preferences. As illustrated in FIGS. 5b, the user may select which POI subjects the user wishes to see.

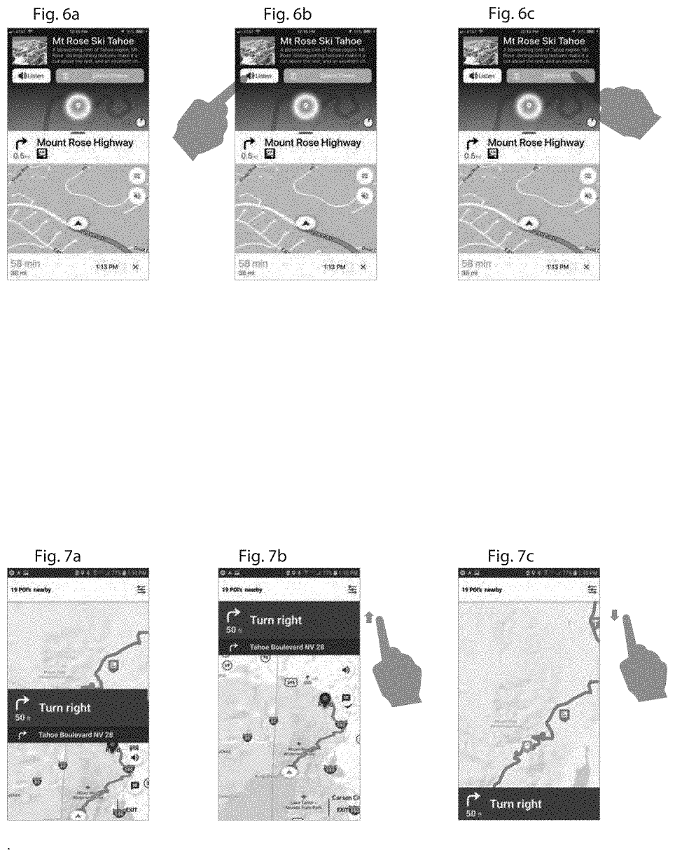

Once the user is en route, the application may then notify the user of up-coming points of interest, such as with an audio alert. The user may have descriptions read (i.e., audibly spoken), so as not to distract the user from driving. The user may then elect to divert the journey to see the point of interest. (See FIGS. 6a-6c). As illustrated in FIGS. 6a, when a POI is in range, an alert may appear on the top section of the screen. As illustrated in FIGS. 6b, the user may have descriptions read to them so as not to distract them from driving. As illustrated in FIGS. 6c, the user may then elect to divert the journey to see the point of interest.

For a non-driving user, the lower Navigation section may be able to collapse, providing a larger view of the upper Trip map and allowing an easier view of points of interest that are farther along on the route. (See FIGS. 7a-7c). As illustrated in FIGS. 7a, an initial display of trip may be displayed. As illustrated in FIGS. 7b, a display with route collapsed and navigation expanded is illustrated. As illustrated in FIGS. 7c, a display with route expanded and navigation collapsed is illustrated.

The application may provide the user with reviews from other visitors as well as media such as pictures and videos. (See FIG. 8).

Once at the location, the user may also contribute to reviews, and supply their own media as well as sharing their experience on their own social network to encourage other visits using the system.

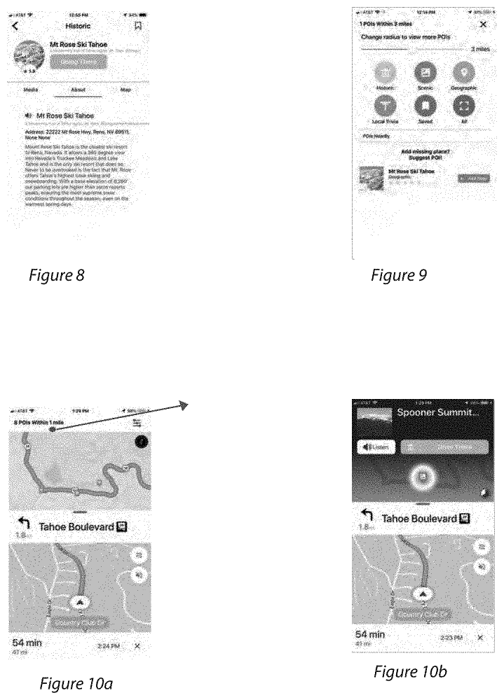

Should the user happen to visit a location that is not currently tracked by the system, the user may submit the user's location with a description to be considered for addition to the system. In this way, the system may grow quickly by using user-submitted content. (See FIG. 9)

The system may explicitly notify people of points of interest (POI's), while the user is driving along a chosen route. (See FIGS. 10a-10b) These POI alerts may be based on the user's preferences and past visiting history.

It is to be understood that this disclosure is not intended to limit the invention to any particular form described, but to the contrary, the invention is intended to include all modifications, alternatives and equivalents falling within the spirit and scope of the invention.

We claim:

1. A system for identifying a point of interest to a user while on a land-based journey, the system comprising:
a cloud-based database soring a plurality of location-based points of interest;
an internet accessible mobile communications device; and
an internet accessible, cloud-based application programming interface (API), the API adapted to permit the mobile communications device to access the cloud-based database;
wherein the mobile communications device is adapted to:
selectively retrieve from the cloud-based database, a location-based point of interest within a user selected distance from a geographical position; and
display to the user the retrieved point of interest.

2. The system of claim 1, wherein the mobile communications device is adapted to:
selectively retrieve from the cloud-based database, a plurality of location-based points of interest within the user selected distance; and
display to the user the plurality of retrieved points of interest.

3. The system of claim 1, wherein the geographical position is determined by the geographical location of the mobile communications device.

4. The system of claim 1, wherein the geographical position is determined by a path defined by the land-based journey.

5. The system of claim 1, wherein the mobile communications device is adapted to upload to the cloud-based database, an additional point of interest.

6. The system of claim 1, wherein the mobile communications device is adapted to permit the user to upload to the cloud-based database, a comment regarding the point of interest.
